(19) United States
(12) Patent Application Publication
(10) Pub. No.: US 2020/0053583 A1
(43) Pub. Date: Feb. 13, 2020

(54) METHOD, NETWORK NODE AND UE FOR HANDLING RRM MEASUREMENTS ON A CARRIER COMPRISING A PLURALITY OF SYNCHRONIZATION SEQUENCE BLOCKS

(71) Applicant: Telefonaktiebolaget LM Ericsson (publ), Stockholm (SE)

(72) Inventors: Helka-Liina Määttänen, Helsinki (FI); Erik Dahlman, Stockholm (SE); Icaro Leonardo J. Da Silva, Solna (SE); Riikka Susitaival, Helsinki (FI)

(21) Appl. No.: 16/301,943

(22) PCT Filed: Sep. 12, 2018
(86) PCT No.: PCT/SE2018/050919

§ 371 Date: Nov. 15, 2018

Related U.S. Application Data
(60) Provisional application No. 62/557,409, filed on Sep. 12, 2017.

(51) Int. Cl. H04W 24/10; H04B 17/309

(52) U.S. Cl. CPC H04W 24/10; H04B 17/309

(57) ABSTRACT

Embodiments herein relate to a method, performed by a User Equipment (UE), for handling Radio Resource Management (RRM) measurements for the UE, on a carrier comprising a plurality of Synchronization Sequence Blocks (SSBs). The UE receives, from a network node, an indication of a Measurement Object (MO) pointing to a frequency location of a primary SSB. The UE further performs measurements on the primary SSB based on the indicated MO. Embodiments herein further relate to a method, performed by a network node, for handling RRM measurements for the UE, on a carrier comprising a plurality of SSBs. The network node determines a primary SSB out of the plurality of SSBs on the carrier. The network node further sends, to the UE, an indication of a MO pointing to a frequency location of the primary SSB.

### TECHNICAL FIELD

Embodiments herein relate to a method, a network node and a User Equipment (UE) for handling RRM measurements on a carrier comprising a plurality of Synchronization Sequence Blocks (SSBs).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Long Term Evolution (LTE) and New Radio (NR) aspects related to physical layer e.g. PSS/SSS transmissions. In Long Term Evolution LTE, a UE performs Radio Resource Management (RRM) measurements primarily based on Primary Synchronization Signal (PSS)/Secondary Synchronization Signal (SSS) and Cell-Specific Reference Signal (CRS). The UE may autonomously find LTE cells based on the carrier frequency information, such as e.g. Evolved Universal Terrestrial Radio Access (E-UTRA) Absolute Radio-Frequency Channel Number (ARFCN), which is given in each Measurement Object (MO) as the PSS/SSS are always transmitted in the center of the carrier frequency.

In New Radio (NR), which may also be referred to as a Fifth Generation (5G) network, a physical cell identity (PCI) is encoded in a so-called NR Synchronization Signal (NR-SS) Block, which may also include an NR-PSS/NR-SSS from which the UE is capable of deriving the NR PCI without prior information about the sequences provided by the network. Differently from LTE, in NR, the Synchronization Signal (SS) Blocks may be transmitted in different and multiple frequency locations, i.e., not only in the center of the carrier frequency.

In 3rd Generation Partnership Project (3GPP) RAN2#99 the following agreements have been made corresponding to the MO:

### AGREEMENTS

1. There is one NR-ARFCN per MO

2. For measurements of carriers where a SSB is not present (measurements performed on Channel State Information Reference Signal (CSI-RS)):
i. MO includes CSI-RS resources for Layer 3 (L3) mobility measurements; and
ii. MO includes some indication that no SSB is provided on this carrier.

3. For measurements of carriers where SSB is present:
If SSB is not located in the centre of the carrier, then offset to the ARFCN provides the location in frequency of the SSB within that carrier.
The agreements above relate to a single BWP in which case the NR ARFCN would be the centre of the BWP.
Further intra- and inter-frequency measurements have been defined in R4-1709108 as follows.
The definitions of intra-frequency and inter-frequency measurements have been discussed and the following conclusion on their definitions have been reached:

SS block (SSB) based RRM Measurements:
SSB based Intra-frequency Measurement: A measurement is defined as a SSB based intra-frequency measurement provided the center frequency of the SSB of the serving cell and the center frequency of the SSB of the neighbour cell are the same, and the subcarrier spacing of the two SSBs are also the same.
SSB based Inter-frequency Measurement: A measurement is defined as a SSB based inter-frequency measurement provided the center frequency of the SSB of the serving cell and the center frequency of the SSB of the neighbour cell are different, or the subcarrier spacing of the two SSBs are different.

The above SSB based measurement definitions assume that only one SSB is transmitted in the same cell. There currently exist certain challenge(s) in the field of RRM measuring. So far it has not been described which assumptions New Radio (NR) should have with respect to a carrier having more than one SSB. One aspect of this is how to perform RRM measurements on a carrier which has multiple SSBs.

### SUMMARY

It is an object of embodiments herein to enhance performance of a wireless communications network, in particular by providing a UE, a network node and methods therein, for handling radio resource management (RRM) measurements for the UE on a carrier comprising a plurality of SSBs. Certain aspects of the present disclosure and their embodiments may provide solutions to these or other challenges. The present disclosure describes measurements, Radio Link Management (RLM) and Handover (HO) and other procedures related to a carrier with multiple SSBs. The term carrier shall herein be interpreted as a cell operating frequency, which may also be referred to as the frequency span in which the cell operates.

The present disclosure further describes one special case of wide carrier with one SSB where required measurements of other bandwidth parts are performed from another reference signal, such as e.g. CSI-RS.

There are, proposed herein, various embodiments which address one or more of the issues mentioned herein.

According to a first aspect of the embodiments herein the object is achieved by a method performed by a UE, for handling radio resource management (RRM) measurements for the UE, on a carrier comprising a plurality of Synchronization Sequence Blocks (SSBs). In this method, the UE receives an indication of a measurement object (MO) pointing to a frequency location of a primary SSB from the network node (200). The UE further performs measurements on the primary SSB based on the indicated MO.

According to a second aspect of the embodiments herein, the object is achieved by a method, performed by a network node, for handling radio resource management (RRM) measurements for a UE on a carrier comprising a plurality of Synchronization Sequence Blocks (SSBs). The network node determines a primary SSB out of the plurality of SSBs on the carrier. The network node further sends an indication of a measurement object (MO) pointing to a frequency location of the primary SSB to the UE.

According to a third aspect of the embodiments herein, the object is achieved by a User Equipment (UE), for handling radio resource management (RRM) measurements for the UE on a carrier comprising a plurality of Synchronization Sequence Blocks (SSBs). The UE (200) is configured to receive, from the network node, an indication of a measurement object (MO) pointing to a frequency location of a primary SSB. The UE further is configured to perform measurements on the primary SSB based on the indicated MO.

According to a fourth aspect of the embodiments herein, the object is achieved by a network node, for handling radio resource management (RRM) measurements for a User Equipment (UE), on a carrier comprising a plurality of Synchronization Sequence Blocks (SSBs). The network node is configured to determine a primary SSB out of the 20 plurality of SSBs on the carrier. The network node is further configured to send, to the UE, an indication of a measurement object (MO) pointing to a frequency location of the primary SSB.

According to a fifth aspect of the embodiments herein, the object is achieved by a 25 computer program product comprising instructions, which, when executed on at least one processor, cause the at least one processor to carry out the method according to the first and/or third aspect of the embodiments herein.

According to a sixth aspect of the embodiments herein, the object is achieved by a computer-readable storage medium, having stored thereon a computer program product comprising instructions which, when executed on at least one processor, cause the at least one processor to carry out the method according the first and/or third aspect of the embodiments herein.

The embodiments herein may provide one or more of the following technical advantage(s). The embodiments herein enable handling of a carrier with multiple SSBs. The embodiments disclosed herein also define how the RRM measurements and other procedures like RLM and HO are performed on a carrier with multiple SSBs.

### BRIEF DESCRIPTION OF THE DRAWINGS

FIG. 1 is a schematic block diagram illustrating embodiments of a wireless communications network,

FIG. 2 is a signaling diagram illustrating the signaling in the communications network for handling RRM measurements in accordance with some embodiments herein,

FIG. 3 is a flowchart depicting a method performed by the network node,

FIG. 4 is a flowchart depicting a method performed by the UE,

FIG. 5 is a schematic block diagram illustrating some first embodiments of a UE,

FIG. 6 is a schematic block diagram illustrating some second embodiments of the UE,

FIG. 7 is a schematic block diagram illustrating some first embodiments of a network node,

FIG. 8 is a schematic block diagram illustrating some second embodiments of the network node,

FIG. 9 is a schematic block diagram illustrating embodiments of the wireless communications network,

FIG. 10 is a schematic block diagram illustrating the UE in accordance with some embodiments,

FIG. 11 is a schematic block diagram illustrating a virtualization environment in accordance with some embodiments,

FIG. 12 is a schematic block diagram illustrating a host computer communicating via a base station with a user equipment over a partially wireless connection in accordance with some embodiments;

FIG. 13 is a schematic overview of a host computer communicating via a base station with a user equipment over a partially wireless connection in accordance with some embodiments;

FIG. 14 is a flowchart depicting methods implemented in a communication system including a host computer, a base station and a user equipment in accordance with some embodiments;

FIG. 15 is a flowchart depicting methods implemented in a communication system including a host computer, a base station and a user equipment in accordance with some embodiments;

FIG. 16 is a flowchart depicting methods implemented in a communication system including a host computer, a base station and a user equipment in accordance with some embodiments;

FIG. 17 is a flowchart depicting methods implemented in a communication system including a host computer, a base station and a user equipment in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In some embodiments herein the non-limiting term UE is used. The UE herein can be any type of wireless device (WD) capable of communicating with a network node or another UE over radio signals. The UE may also be a radio communication device, target device, device to device (D2D) UE, machine type UE or a UE capable of machine to machine communication (M2M), a sensor equipped with UE, an iPAD, a tablet, mobile terminals, smart phone, laptop embedded equipped (LEE), laptop mounted equipment (LME), USB dongles, Customer Premises Equipment (CPE) etc. In the following, the terms UE and WD are used interchangeably.

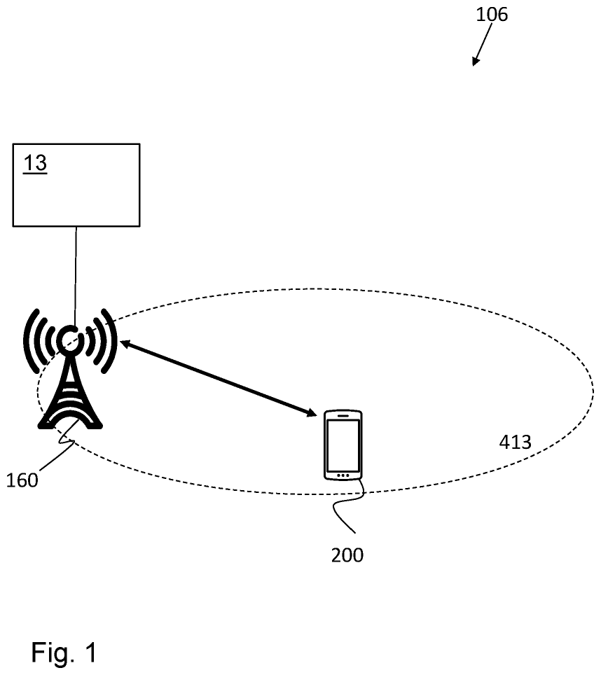

FIG. 1 illustrates a communication scenario in an exemplified wireless communication network 106, where at least some of the embodiments herein may be used. Another example of a communication scenario is described in more detail in FIG. 9, however a simplified version is shown in FIG. 1 in order to provide a better understanding of the embodiments disclosed herein. The wireless communication network 106 comprises one or more UEs 200. The UEs 200 may e.g. be mobile phones, smart phones, laptop computers, tablet computers, Machine-Type Communication (MTC) devices, mobile stations, stations (STA), or any other devices that can provide wireless communication. Each UE 200 may thus also be referred to as a wireless device. The UE 200 may communicate via the wireless communication network 106, such as a Local Area Network (LAN), such as e.g. a Wi-Fi network, or a Radio Access Network (RAN), such as e.g. an Evolved Universal Terrestrial Radio Access Network (E-UTRAN) or a Fifth Generation (5G) RAN to a backhaul network 13, such as e.g. an Evolved Packet Core (EPC) or a 5th Generation Core (5GC). The wireless communication network 106 further comprises one or more network nodes 160, such as e.g. a radio access node e.g., a Wi-Fi access point or a radio base station (RBS), which in some networks may also be denoted, for example, a NodeB, an E-Utran NodeB (eNB), or a gNB as denoted in New Radio (NR). NR may also be referred to as 5th-Generation Wireless Systems (5G). Each of the one or more network node(s) 160 serves one or more coverage area(s) 413, which may also be referred to as e.g. a cell, a beam or a beam group. In order to determine the best available cell for the UE 200, the UE 200 may perform measurements, which may also be referred to as mobility measurements, in order to monitor and report the serving cell and neighboring cell(s) signal level and quality. The measurements may then be sent from the UE 200 to the network node 160 and may be used to assist the network node 160 to choose a suitable serving cell for the UE 200. There may be different reasons to relocate the UE 200 from a current serving cell to another cell, such as e.g. coverage reasons, traffic load level or support of a specific service.

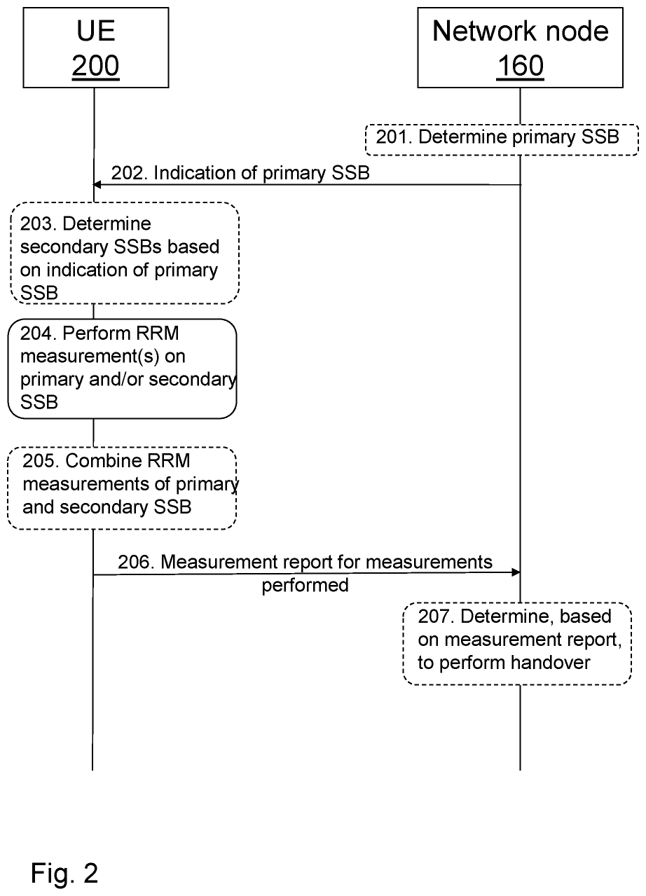

According to a first scenario, the UE 200 may perform measurements on other cells on the same carrier as transmitted in cell 413 or on a different carrier. The term carrier shall herein be interpreted as a cell operating frequency, i.e. the frequency on which the cell operates. For a carrier which has more than one SSB, such as e.g. two SSBs, a primary SSB is defined for that carrier. The primary SSB may herein also be referred to as a Cell-Defining SSB (CD-SSB). This is similar to action 201 in FIG. 2. Defining of the primary SSB may be performed by the network 106, such as by the network node 160. The primary SSB may correspond to the SSB of a carrier which has only a single SSB. Or, the other way around, a carrier which has been defined to have at least one SSB has always a primary SSB. If a carrier has more SSBs, those may be referred to as secondary SSBs.

This means that when the UE 200 is configured to perform RRM measurements, the measurement object (MO) may point to the frequency location where the primary SSBs of the cells are located. The UE 200 performing RRM measurements may measure the primary SSB as if it is the only SSB of that carrier. In other words, when the UE 200 performs RRM measurements it performs these measurements on the primary SSB in the same way as if the carrier would only have one SSB. The MO may be received by the UE 200 when transmitted from a network node 160, such as e.g. in a Radio Resource Control (RRC) configuration message or a similar message. The MO pointing to the frequency location of the primary SSB may e.g. be received by the UE 200 by receiving an indication of the MO from the network node 160, which indication indicates a certain MO out of a plurality of MOs which may e.g. be stored in the UE 200.

The UE 200 may be configured to measure only one of the SSBs, such as e.g. the primary SSB, thus from a UE 200 perspective there is only one SSB per cell and/or SSB center carrier per frequency. Under this assumption, when the UE 200 is operating with a bandwidth part covering one SSB, such as the primary SSB, the UE 200 may be configured to measure another SSB, such as the secondary SSBs, belonging to the same cell. This measurement configuration may be a special configuration which indicates that the measurement is an own cell SSB measurement from another frequency location. The term “Own cell” shall herein be interpreted as the serving cell, i.e. the cell serving the UE 200. The configuration may however also be a normal MO pointing to that frequency location and the UE 200 may search all cells found. Hence, the MO may point to the frequency location of one or more secondary SSBs. However, when reporting, the UE 200 may indicate that the reports are related to the own Physical Cell Identity (PCI) in order to prevent PCI confusion. The UE 200 may be configured by receiving an RRC configuration message comprising the relevant information for configuring the UE 200 from the network node 160. The information may e.g. comprise an indication of the MO which the UE 200 shall use.

According to a second scenario, the UE 200 may perform measurements on the own cell but on a different bandwidth part than the one the UE 200 is currently operating on.

In another embodiment, the UE 200 may be configured to combine the measurements from the two SSBs. Combining the measurements may include an average over the measurement quantity, such as e.g. Reference Signal Received Power (RSRP) or Reference Signal Received Quality (RSRQ), selection of the measurement quantity, and/or reporting measurement quantity on both SSBs where a second report may be relative to a first report. The first report may comprise the measurement results for the primary SSB and the second report may comprise the measurement results for the secondary SSB. The UE 200 may e.g. be configured to combine the measurements by means of the network node 160, such as e.g. by receiving an RRC configuration message or a similar message from the network node 160. The configuration message may comprise a configuration indicating that the UE 200 shall combine the measurements from the two SSBs, such as from the primary SSB and the secondary SSB. The UE 200 may however also be configured to combine measurements from more than two SSBs, such as e.g. the primary SSB and a plurality of secondary SSBs.

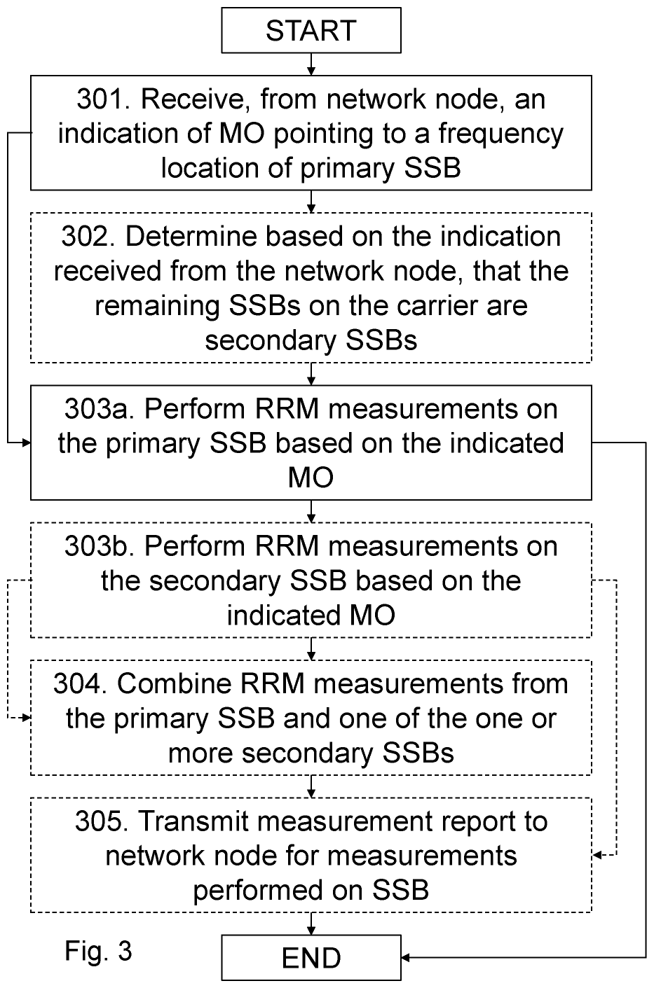

In another embodiment, the UE 200 may be configured to use the primary SSB to perform serving cell RRM measurements, such as e.g. Primary Cell (PCell) RSRP, RSRQ and Signal-to-Interference-plus-Noise-Ratio (SINR) measurements. This is similar to action 204 in FIG. 2 and action 303 in FIG. 3. The network, such as e.g. the network node 160, may configure the UE 200 with a MO in the same frequency position of its primary SSB so that the UE 200 is able to find intra-frequency neighbor cells without the need of measurement gaps. The network node 160 may e.g. configure the UE 200 by sending an RRC configuration message comprising information that is relevant for configuring the UE 160.

The network may re-configure the connected UE 200 to use a bandwidth part where another SSB that is not the primary SSB, such as e.g. a secondary SSB, is also being transmitted. In that case, one option may be that the UE keeps using the primary SSB to perform serving cell measurement and neighbor cell measurements for the same measurement object. In that case the network may configure the UE 200 with measurement gaps even for intra-cell measurements. The network 106, such as the network node 160, may e.g. re-configure the UE 200 to use a bandwidth part by performing an RRC mobility procedure. Such an RRC mobility procedure may herein also be referred to as a handover or a re-configuration with sync.

In some embodiments, only the primary SSB may be used for initial access and may have a Physical Broadcast Channel (PBCH) from which an SSB beam index and a frame timing may be obtained. As PBCH is assumed for RSRP/RSRQ measurements, RRM measurements may only be performed based on the primary SSB. The primary SSB may be identified by the SSB beam index and frame timing.

The secondary SSB may only have, which may also be referred to as comprise, NR-PSS and NR-SSS which may be used to obtain sync. If measurements are needed from the frequency range of the secondary SSB, another Reference Signal (RS) may be used, such as e.g. Channel State Information-Reference Signals (CSI-RS). The UE may acquire a timing reference for making measurements in a carrier, e.g. by assuming the timing reference from one of its serving carriers, in case of carrier aggregation (CA), or may receive a MO comprising a pointer to another carrier with SSB for obtaining the timing reference.

When the UE 200 has been moved within the cell to the other bandwidth part (BWP), which may also be referred to as a “new BWP”, which BWP covers the other SSB which may also be referred to as the second SSB, secondary SSB or “new SSB”, the network may configure the UE 200 to perform RRM measurements based on the new SSB that is not the primary SSB. The movement of the UE 200 to another BWP may herein also be referred to as a handover or a re-configuration with sync. That new SSB might have been previously pre-configured when the UE 200 has setup the connection or resumed and activated the connection when the UE 200 is configured to use a new bandwidth part. The new SSB may also be configured at the moment the UE 200 is re-configured to use a given bandwidth part. The UE 200 may be configured to use the same frequency position of the new SSB to find intra-frequency neighbor cells. That re-configuration may either be explicit or implicit, e.g., when the UE 200 receives an indication that a given bandwidth part is to be used the UE 200 starts using the closest SSB. The UE 200 may know about the closest SSB, e.g. by being hard coded into the UE 200 or by receiving a configuration message from the network node 160. The network node 160 may e.g. configure the UE 200 to measure on a certain SSB by configuring UE with multiple MOs, where one MO points to a frequency location of the desired SSB. The different MOs may be indexed and stored in the UE 200 and the network node may indicate the MO by sending the index of the MO to the UE 200 to indicate which SSB is the primary SSB to be used by the UE 200. The indication may e.g. be sent in an RRC Connection Reconfiguration message. This is similar to action 202 in FIG. 2.

The network, such as the network node 160, may also configure the UE 200 to perform Radio Link Management (RLM) based on multiple SSBs. Upon the re-configuration of bandwidth parts, the UE 200 may also change the SSB that is used by the UE to perform RLM related measurements, since these would be better correlated with the re-configured Physical Downlink Control Channel (PDCCH) resources.

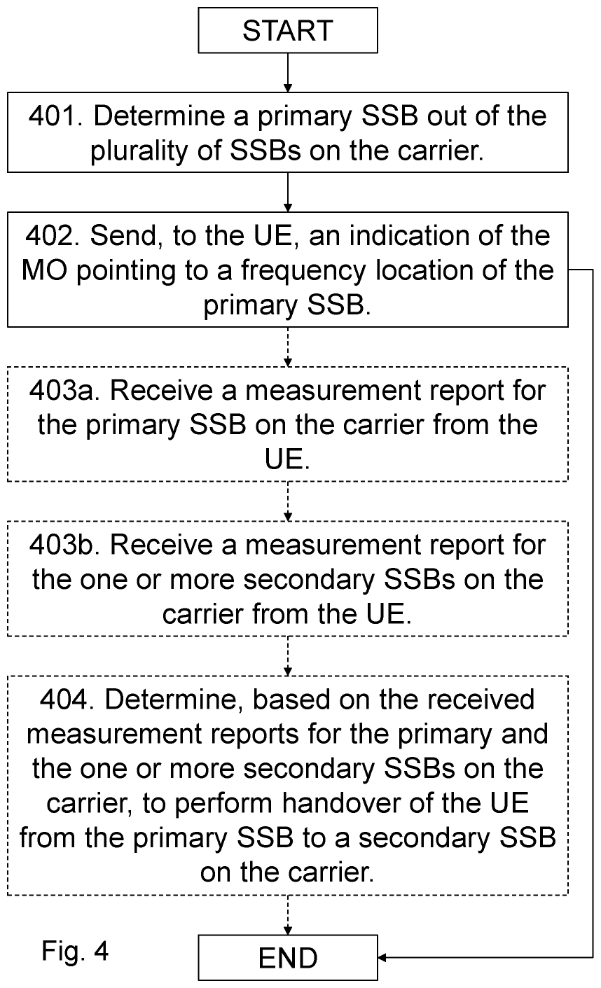

The network 106 may, e.g. by means of the network node 160, also send a handover command associated to a given target cell to any of the transmitted SSBs associated to the target cell, regardless which SSB the UE has been performing measurements and reporting on, in order to perform a handover of the UE 200. A mobilityControllnfo sent from the network to the UE 200 may comprise the PCI and a frequency shift associated to the carrier and/or MO. In another embodiment the mobilityControllnfo may comprise the PCI and multiple frequency shifts so that the UE 200 is allowed to select Random Access Channel (RACH) resources associated to any of the provided SSBs. This is similar to action 207 in FIG. 2 and action 404 in FIG. 4.

In some embodiments the network, such as e.g. the network node 160, may also configure the UE 200 to select any of the transmitted SSBs associated to its serving cell to perform beam selection upon beam failure. The UE 200 may stay in the same cell but may use multiple SSBs. Another option may be to define some level of prioritization, where the UE 200 first tries the SSBs and/or beams associated to the primary SSB, then the secondary SSBs and so on. The network may perform the configuration of the UE 200 by sending an RRC configuration message or a similar message to the UE 200 by means of the network node 160.

In all of the above embodiments, the SSBs may have the mentioned distinction of primary or secondary SSBs, or the multiple SSBs have no distinction of priority, that is 25 primary vs secondary. In the latter case the SSBs may have indexes to make the separation, or the SSBs may be identified by the center frequency of the SSB, or the SSBs may be identified by frequency location via an offset from the carrier NR-ARFCN.

FIG. 2 illustrates a signaling diagram for the method for handling RRM measurements on a carrier comprising a plurality of SSBs.

Action 201: The network node 160 may determine, which may herein also be referred to as define, a primary SSB out of the plurality of SSBs on the carrier. This action corresponds to action 401 described in relation to FIG. 4.

Action 202: The network node 160 may send, to the UE 120, an indication of a MO pointing to a frequency location of the primary SSB. The indication may e.g. be sent in an RRC configuration message. This action corresponds to action 301 described in relation to FIG. 3 and action 402 described in relation to FIG. 4.

Action 203: The UE 200 may determine, based on the indication received from the network node 160, that the remaining SSBs on the carrier are secondary SSBs.

This action 203 corresponds to the action 302 described in relation to FIG. 3.

Action 204: The UE 200 performs RRM measurements on the primary SSB based on the indicated MO. The UE 200 may further perform RRM measurements on the one or more secondary SSBs of the carrier. This action 204 is similar to the action 303a and 303b described in relation to FIG. 3.

Action 205: The UE 200 may combine RRM measurements from the primary SSB and one of the one or more secondary SSBs. The combining of RRM measurements may comprise averaging over a measurement quantity, wherein the measurement quantity is a RSRP or a RSRQ. This action 205 corresponds to the action 304 described in relation to FIG. 3.

Action 206: The UE 200 may further transmit, to the network node 160, a measurement report for the measurements performed on the SSB based on the MO indicated by the received indication. This action 206 corresponds to the action 305 described in relation to FIG. 3.

Action 207: The network node 160 may determine, based on the received measurement reports for the primary and the one or more secondary SSBs on the carrier, to perform handover of the UE 200 from the primary SSB to a secondary SSB on the carrier. This action 207 corresponds to the action 404 described in relation to FIG. 4.

FIG. 3 illustrates the method actions performed by the UE 200, for handling RRM measurements for the UE 200, on a carrier comprising a plurality of SSBs.

Action 301: The UE 200 receives, from the network node 200, an indication of a MO pointing to a frequency location of a primary SSB. The frequency location may be pointed to by indexing the SSBs. In other words, the indicated MO may point to the frequency location by indexing the SSBs. The SSBs may be indexed and stored on the UE 200, e.g. by providing a MO comprising information about the frequency position of the SSB for each SSB and indexing the MOs. The UE 200 may receive an indication from the network node 160, which indication indicates the index of the MO comprising the frequency position of the desired SSB.

The frequency location may however also be pointed to by indicating a center frequency of the SSB or by indicating an offset from an Absolute Radio-Frequency Channel Number (ARFCN). The indicated MO may e.g. point to the frequency location by indicating a center frequency of the SSB or by indicating an offset from the ARFCN.

Action 302: The UE 200 may determine based on the indication received from the network node 160, that the remaining SSBs on the carrier are secondary SSBs.

The UE 200 may e.g. be configured with a plurality of MOs pointing to the frequency locations of the various SSBs. Based on the indication of the MO pointing towards the frequency location of the primary SSB the UE 200 may determine that the remaining MOs out of the plurality of MOs points towards secondary SSBs.

Action 303a: The UE 200 performs RRM measurements on the primary SSB based on the indicated MO.

Action 303b: The UE 200 performs RRM measurements on the one or more secondary SSBs of the carrier.

Action 304: The UE 200 may combine RRM measurements from the primary SSB and one of the one or more secondary SSBs. The combining of RRM measurements may comprise averaging over a measurement quantity, wherein the measurement quantity is a RSRP or a RSRQ.

Action 305: The UE 200 may further transmit, to the network node 160, a measurement report for the measurements performed on the SSB based on the MO indicated by the received indication. The measurement report may comprise the measurements performed on the primary SSB, the secondary SSB and/or on the combination thereof.

FIG. 4 illustrates the method actions performed by the network node 160, for handling RRM measurements for the UE 200, on a carrier comprising a plurality of SSBs.

Action 401: The network node 160 determines a primary SSB out of the plurality of SSBs on a carrier.

Action 402: The network node 160 sends, to the UE 200, an indication of the MO pointing to a frequency location of the primary SSB. The frequency location may be pointed to by indexing the SSBs. The SSBs may be indexed and stored on the UE 200, e.g. by providing a MO comprising information about the frequency position of the SSB for each SSB and indexing the MOs. The network node 160 may send an indication to the UE 200, which indication indicates the index of the MO comprising the frequency position of the desired SSB.

The frequency location may however also be pointed to by the network sending an indication indicating the center frequency of the SSB or by indicating the offset from an ARFCN.

Action 403a: The network node 160 may receive a measurement report for the primary SSB on the carrier from the UE 200.

Action 403b: The network node 160 may further receive a measurement report for the one or more secondary SSBs on the carrier from the UE 200. The measurement report may report measurements performed on the SSB based on the MO indicated by the received indication.

Action 404: The network node 160 may determine, based on the received measurement reports for the primary and the one or more secondary SSBs on the carrier, to perform handover of the UE 200 from the primary SSB to a secondary SSB on the carrier.

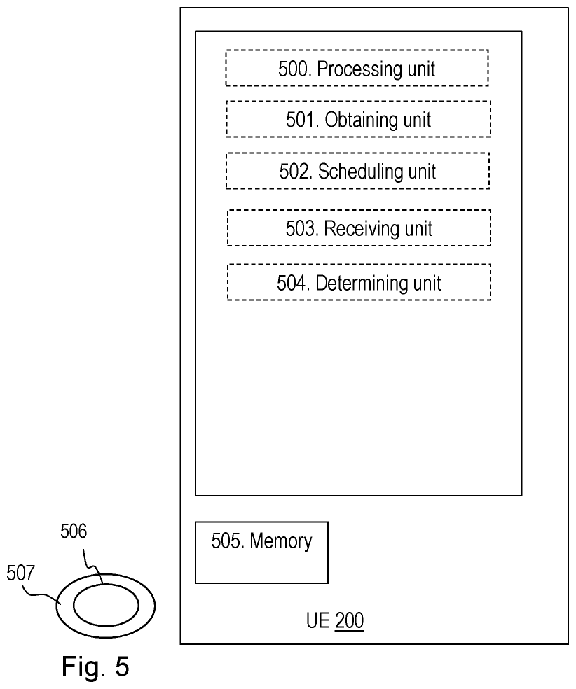

FIG. 5 is a block diagram depicting the UE 200, for handling RRM measurements for the UE 200, on a carrier comprising a plurality of SSBs. The UE 200 may comprise a processing unit 500, such as e.g. one or more processors, a receiving unit 501, a measuring unit 502 and/or a determining unit 503 and/or a combining unit 504 and/or a transmitting unit 505 as exemplifying hardware units configured to perform the method as described herein for the UE 200.

The UE 200 is configured to, e.g. by means of the processing unit 500 and/or the receiving unit 501 being configured to, receive, from the network node 160, an indication of a MO pointing to a frequency location of the primary SSB.

The UE 200 is further configured to, e.g. by means of the processing unit 500 and/or the measuring unit 502 being configured to, perform measurements on the primary SSB based on the indicated MO.

The UE 200 may further be configured to, e.g. by means of the processing unit 500 and/or the determining unit 503 being configured to, determine based on the indication received from the network node, that the remaining SSBs on the carrier are secondary SSBs.

The UE 200 may further be configured to, e.g. by means of the processing unit 500 and/or the measuring unit 502 being configured to, perform RRM measurements on the one or more secondary SSBs of the carrier.

The UE 200 may further be configured to, e.g. by means of the processing unit 500 and/or the combining unit 504 being configured to, combine RRM measurements from the primary SSB and one of the one or more secondary SSBs.

The UE 200 may further be configured to, e.g. by means of the processing unit 500 and/or the combining unit 504 being configured to, combine the RRM measurements by averaging over a measurement quantity, wherein the measurement quantity is a RSRP or a RSRQ.

The UE 200 may further be configured to, e.g. by means of the processing unit 500 and/or the transmitting unit 505 being configured to, transmit, to the network node 160, a measurement report based on the MO indicated by the received indication.

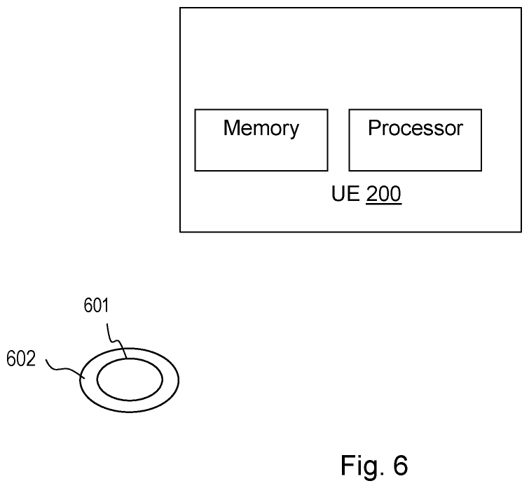

The embodiments herein may be implemented through a respective processor or one or more processors of a processing circuitry in the radio network node 160 as depicted in FIG. 6, which processing circuitry is configured to perform the method actions according to FIG. 5 and the embodiments described above for the UE 200.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the UE 200. One such carrier may be in the form of a CD ROM disc. It is however feasible with other data carriers such as e.g. a memory stick. The computer program code may furthermore be provided as pure program code on a server and downloaded to the UE 200.

The UE 200 may further comprise a memory 505. The memory may comprise one or more memory units to be used to store data on, such as software, patches, system information (SI), configurations, diagnostic data, performance data and/or applications to perform the methods disclosed herein when being executed, and similar.

The method according to the embodiments described herein for the UE 200 may be implemented by means of e.g. a computer program product 506, 601 or a computer program, comprising instructions, i.e., software code portions, which, when executed on at least one processor, cause at least one processor to carry out the actions described herein, as performed by the UE 200. The computer program product 506, 601 may be stored on a computer-readable storage medium 507, 602, e.g. a disc or similar. The computer-readable storage medium 507, 602, having stored thereon the computer program, may comprise instructions which, when executed on at least one processor, cause the at least one processor to carry out the actions described herein, as performed by the UE 200. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a UE.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

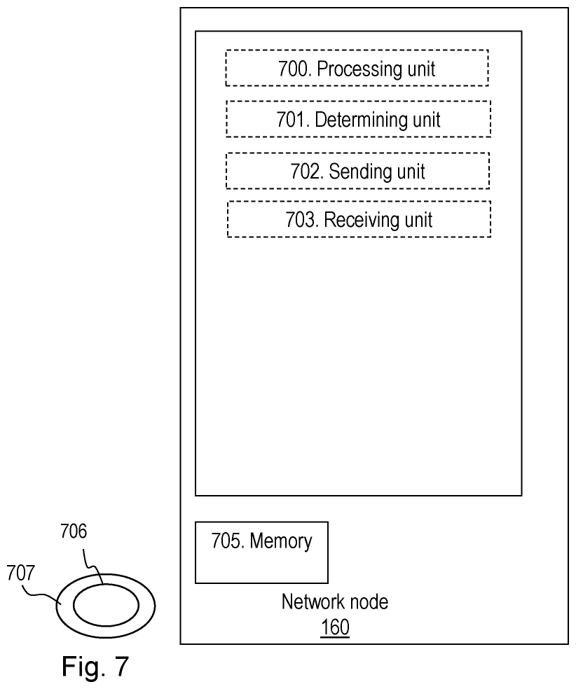

FIG. 7 is a block diagram depicting the network node 160, for handling RRM measurements for the UE 200 on a carrier comprising a plurality of SSBs. The radio network node 160 may comprise a processing unit 700, such as e.g. one or more processors, a determining unit 701, a sending unit 702, and/or a receiving unit 703 as exemplifying hardware units configured to perform the method as described herein for the network node 160.

The network node 160 is configured to, e.g. by means of the processing unit 700 and/or the determining unit 701 being configured to, determine a primary SSB out of the plurality of SSBs on the carrier.

The network node 160 is configured to, e.g. by means of the processing unit 700 and/or the sending unit 702 being configured to, send an indication of a MO pointing to a frequency location of the primary SSB to the UE 200.

The network node 160 may further be configured to, e.g. by means of the processing unit 700 and/or the receiving unit 703 being configured to, receive a measurement report for the primary SSB on the carrier from the UE 200.

The network node 160 may further be configured to, e.g. by means of the processing unit 700 and/or the receiving unit 703 being configured to, receive a measurement report for the one or more secondary SSBs on the carrier from the UE 200.

The network node 160 is configured to, e.g. by means of the processing unit 700 and/or the determining unit 701 being configured to, determine, based on the received measurement reports for the primary and the one or more secondary SSBs on the carrier, to perform handover of the UE 200 from the primary SSB to a secondary SSB on the carrier.

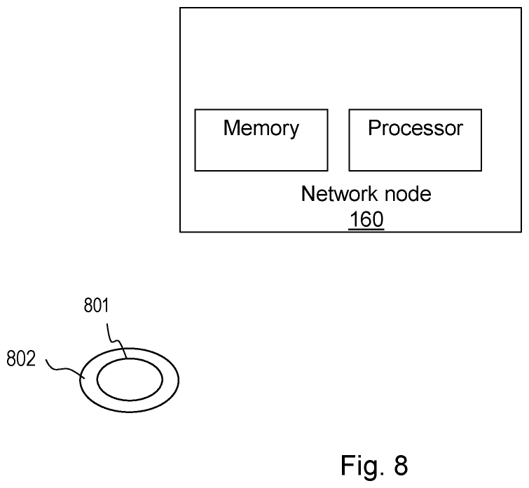

The embodiments herein may be implemented through a respective processor or one or more processors of a processing circuitry in the network node 160 as depicted in 15 FIG. 8, which processing circuitry is configured to perform the method actions according to FIG. 2 and the embodiments described above for the network node 160.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the network node 160. One such carrier may be in the form of a CD ROM disc. It is however feasible with other data carriers such as e.g. a memory stick. The computer program code may furthermore be provided as pure program code on a server and downloaded to the network node 160.

The network node 160 may further comprise a memory 705. The memory may comprise one or more memory units to be used to store data on, such as software, patches, system information, configurations, diagnostic data, performance data and/or applications to perform the methods disclosed herein when being executed, and similar.

The method according to the embodiments described herein for the network node 160 may be implemented by means of e.g. a computer program product 706, 801 or a computer program, comprising instructions, i.e., software code portions, which, when executed on at least one processor, cause at least one processor to carry out the actions described herein, as performed by the network node 160. The computer program product 706, 801 may be stored on a computer-readable storage medium 707, 802, e.g. a disc or similar. The computer-readable storage medium 707, 802, having stored thereon the computer program, may comprise instructions which, when executed on at least one processor, cause the at least one processor to carry out the actions described herein, as performed by the network node 160. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a network node.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

The network node 160, described in the embodiments herein may also be implemented in a cloud. Although the method actions performed by the network node 160 herein are discussed in the context of a radio network node, the method may also be performed by a core network node or a distributed node comprised in a first cloud, such as e.g. a server and/or a datacenter. The method actions may e.g. be performed by a logical function, which may be a centralized service hosted on the core network node or the distributed node.

It shall be noted that the nodes mentioned herein may be arranged as separate nodes or may be collocated within one or more nodes in the communications network. When a plurality of nodes are collocated in one node, the single node may be configured to perform the actions of each of the collocated nodes.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., Mobile Switching Centers (MSCs), Mobility Management Entities (MMEs), Operation and Maintenance (O&M) nodes, Operations Support System (OSS) nodes, Self Optimized Network (SON) nodes, positioning nodes such as e.g., Evolved-Serving Mobile Location Centre (E-SMLCs), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 160 includes processing circuitry 170, device readable medium 180, interface 190, auxiliary equipment 184, power source 186, power circuitry 187, and antenna 162. Although network node 160 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 8 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. . . . A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

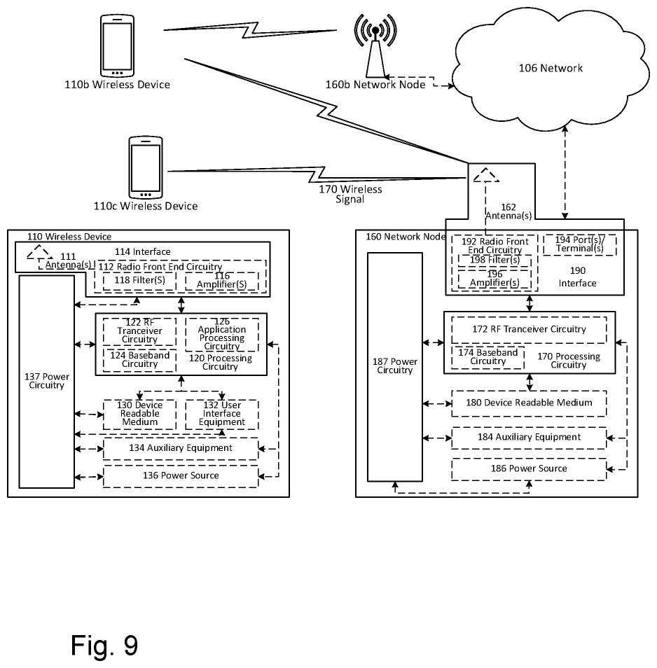

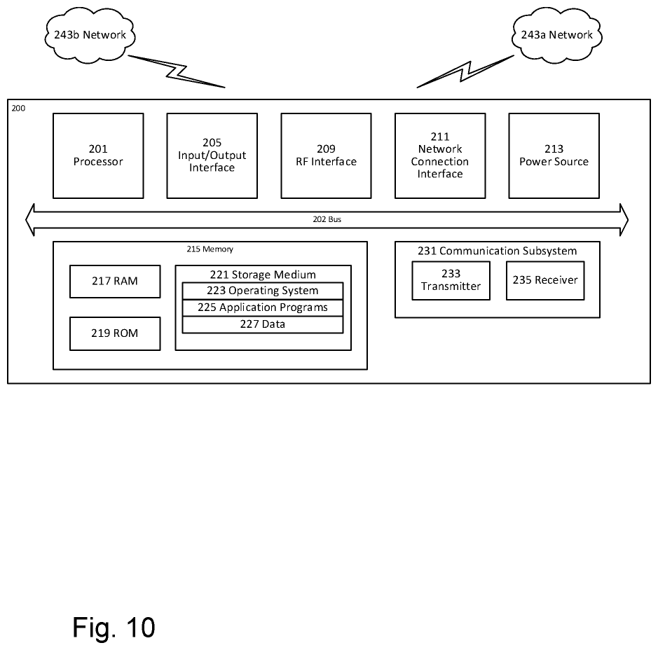

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3GPP, including a NB-IoT UE, a machine type communication (MTC) UE, and/or an enhanced MTC (eMTC) UE. UE 200, as illustrated in FIG. 10, is one example of a WD configured for communication in accordance with one or more communication standards promulgated by the 3GPP, such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 10, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a RAN according to one or more communication protocols, such as IEEE 802.2, Code Division Multiplexing Access (CDMA), Wide Code Division Multiplexing Access (WCDMA), GSM, LTE, Universal Terrestrial Radio Access Network (UTRAN), WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

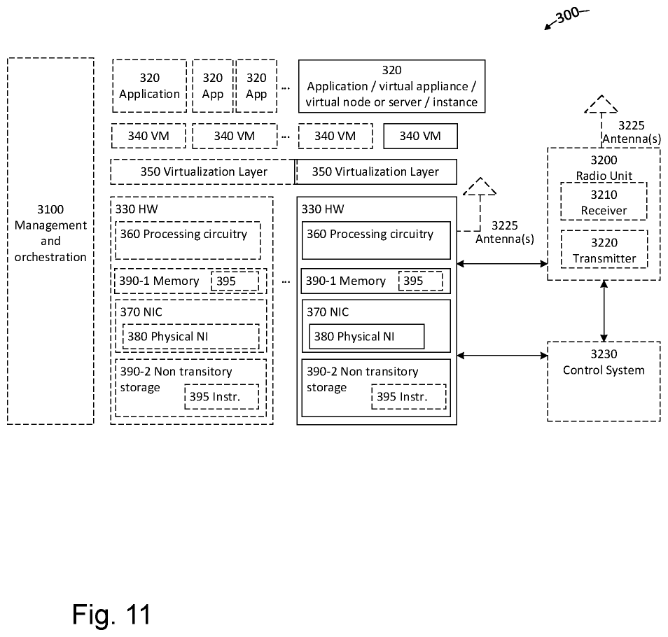

FIG. 11 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 11, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 11.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

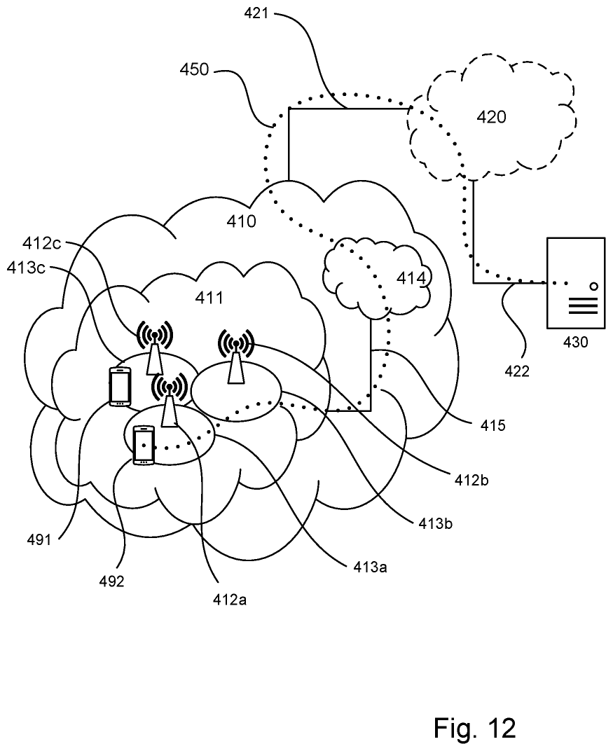

With reference to FIG. 12, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink (UL) and downlink (DL) communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

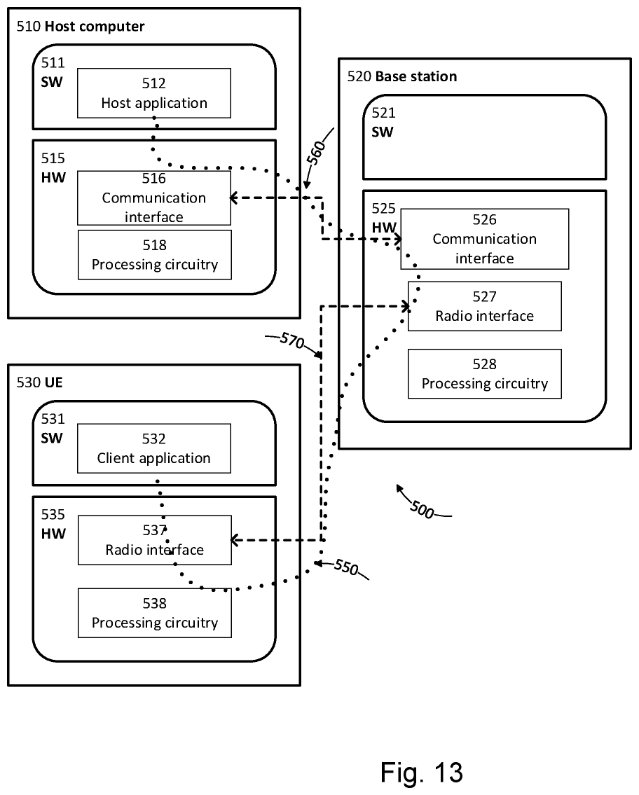

Example implementations, in accordance with an embodiment, of the UE, base station and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by base station 520. Communication interface 526 may be configured to facilitate connection 560 to host computer 510. Connection 560 may be direct or it may pass through a core network (not shown in FIG. 13) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 13 may be similar or identical to host computer 430, one of base stations 412a, 412b, 412c and one of UEs 491, 492 of FIG. 12, respectively. This is to say, the inner workings of these entities may be as shown in FIG. 13 and independently, the surrounding network topology may be that of FIG. 12.

In FIG. 13, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the handling of carriers having multiple SSBs and thereby provide benefits such as improved quality of transmissions and improved performance of the communications network.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

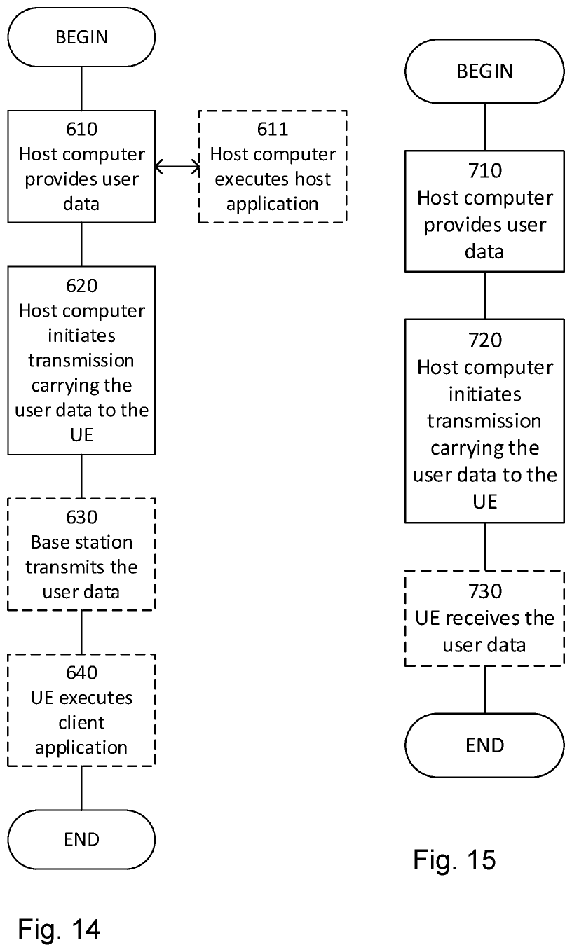

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

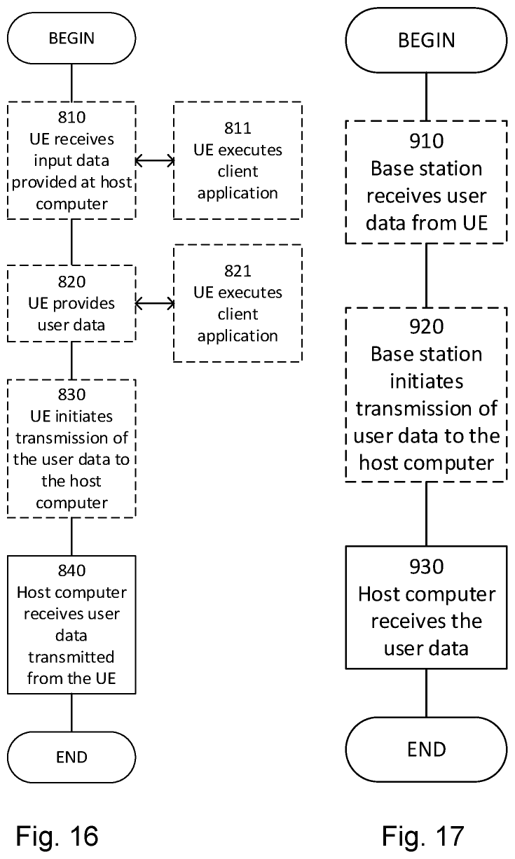

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

1. A method, performed by a User Equipment, UE, for handling radio resource management, RRM, measurements for the UE, on a carrier comprising a plurality of Synchronization Sequence Blocks, SSBs, wherein the method comprises:
receiving, from the network node, an indication of a measurement object, MO, pointing to a frequency location of a primary SSB, and
performing measurements on the primary SSB based on the indicated MO.

2. The method according to claim 1, wherein the method further comprises:
determining based on the indication received from the network node, that the remaining SSBs on the carrier are secondary SSBs, and
performing RRM measurements on the one or more secondary SSBs of the carrier.

3. The method according to claim 2, wherein the method further comprises
combining RRM measurements from the primary SSB and one of the one or more secondary SSBs.

4. The method according to claim 3, wherein the combining of RRM measurements comprises averaging over a measurement quantity, wherein the measurement quantity is a Reference Signal Received Power, RSRP, or a Reference Signal Received Quality, RSRQ.

5. The method according to claim 1, wherein the indicated MO points to the frequency location by indexing the SSBs.

6. The method according to claim 1, wherein the indicated MO points to the frequency location by indicating a center frequency of the SSB; or by indicating an offset from an Absolute Radio-Frequency Channel Number, ARFCN.

7. The method according to claim 1, wherein the method further comprises:
transmitting, to the network node, a measurement report based on the MO indicated by the received indication.

8. A method, performed by a network node, for handling radio resource management, RRM, measurements for a User Equipment, UE, on a carrier comprising a plurality of Synchronization Sequence Blocks, SSBs, wherein the method comprises:
determining a primary SSB out of the plurality of SSBs on the carrier, and
sending, to the UE, an indication of a measurement object, MO, pointing to a frequency location of the primary SSB.

9. The method according to claim 8, wherein the method further comprises:
receiving, from the UE, a measurement report for the primary SSB on the carrier.

10. The method according to claim 9, wherein the method further comprises:
receiving, from the UE, a measurement report for the one or more secondary SSBs on the carrier.

11. The method according to claim 10, wherein the method further comprises:
determining, based on the received measurement reports for the primary and the one or more secondary SSBs on the carrier, to perform handover of the UE from the primary SSB to a secondary SSB on the carrier.

12. A User Equipment, UE, for handling radio resource management, RRM, measurements for the UE, on a carrier comprising a plurality of Synchronization Sequence Blocks, SSBs, wherein the UE is configured to:
receive, from the network node, an indication of a measurement object, MO, pointing to a frequency location of a primary SSB, and
perform measurements on the primary SSB based on the indicated MO.

13. The UE according to claim 12, wherein the UE is further configured to:
determine based on the indication received from the network node, that the remaining SSBs on the carrier are secondary SSBs, and
perform RRM measurements on the one or more secondary SSBs of the carrier.

14. The UE according to claim 13, wherein the UE is further configured to:
combine RRM measurements from the primary SSB and one of the one or more secondary SSBs.

15. The UE according to claim 14, wherein the UE is configured to combine the RRM measurements by averaging over a measurement quantity, wherein the measurement quantity is a Reference Signal Received Power, RSRP, or a Reference Signal Received Quality, RSRQ.

16. The UE according to claim 12, wherein the UE is further configured to:
transmit, to the network node, a measurement report based on the MO indicated by the received indication.

17. A network node, for handling radio resource management, RRM, measurements for a User Equipment, UE, on a carrier comprising a plurality of Synchronization Sequence Blocks, SSBs, wherein the network node is configured to:
determine a primary SSB out of the plurality of SSBs on the carrier, and
send, to the UE, an indication of a measurement object, MO, pointing to a frequency location of the primary SSB.

18. The network node according to claim 17, wherein the network node further is configured to:
receive, from the UE, a measurement report for the primary SSB on the carrier.

19. The network node according to claim 18, wherein the network node further is configured to:
receive, from the UE, a measurement report for the one or more secondary SSBs on the carrier.

20. The network node according to claim 19, wherein the network node further is configured to:
determine, based on the received measurement reports for the primary and the one or more secondary SSBs on the carrier, to perform handover of the UE from the primary SSB to a secondary SSB on the carrier.

21. (canceled)

22. (canceled)

23. A non-transitory computer-readable storage medium comprising a computer program product including instructions to cause at least one processor to:
receive, from the network node, an indication of a measurement object, MO, pointing to a frequency location of a primary Synchronization Sequence Block, SSB, and
perform measurements on the primary SSB based on the indicated MO.
